(19) United States
(12) Patent Application Publication
(10) Pub. No.: US 2018/0077163 A1
(43) Pub. Date: Mar. 15, 2018

(54) POTENTIAL BLOCKING IMPACTS

(71) Applicant: Trend Micro Incorporated, Tokyo (JP)

(72) Inventors: Vaughn Kristopher EIFLER, Austin, TX (US); Jonathan Edward ANDERSSON, Austin, TX (US); Josiah Dede HAGEN, Austin, TX (US)

(73) Assignee: Trend Micro Incorporated, Tokyo (JP)

(21) Appl. No.: 15/815,487

(22) Filed: Nov. 16, 2017

Related U.S. Application Data
(63) Continuation of application No. PCT/US2015/033343, filed on May 29, 2015.

(51) Int. Cl. H04L 29/06; H04L 12/26; G06Q 10/10

(52) U.S. Cl. CPC H04L 63/101; H04L 43/04; G06Q 10/107; H04L 51/12; H04L 63/1425; H04L 2463/144; H04L 63/0236

(57) ABSTRACT

Examples disclosed herein relate to potential blocking impacts. Some of the examples enable obtaining network traffic data of a network that is accessible by a plurality of users. The network traffic data may comprise occurrences of a reputable entity. Some of the examples further enable determining, based on the network traffic data, a potential blocking impact of blocking the reputable entity from the network. Some of the examples further enable providing the potential blocking impact to be used in an application of a network policy to the reputable entity.

### CROSS-REFERENCE TO RELATED APPLICATION

This application is a continuation of International Application No. PCT/US2015/033343, with an International Filing Date of May 29, 2015, which is incorporated herein by reference in its entirety.

### BACKGROUND

A blacklist may comprise a plurality of reputable entities (e.g., Internet Protocol (IP) addresses, domain names, e-mail addresses, Uniform Resource Locators (URLs), files, software versions, security certificates, etc.). For example, the blacklist may be used to block, filter out, and/or deny access to certain resources by an event that matches at least one of the plurality of reputable entities.

### BRIEF DESCRIPTION OF THE DRAWINGS

The following detailed description references the drawings, wherein:

FIG. 1 is a block diagram depicting an example environment in which various examples may be implemented as a potential blocking impacts system.

FIG. 2 is a block diagram depicting an example potential blocking impacts system.

FIG. 3 is a block diagram depicting an example machine-readable storage medium comprising instructions executable by a processor for determining potential blocking impacts.

FIG. 4 is a block diagram depicting an example machine-readable storage medium comprising instructions executable by a processor for determining potential blocking impacts.

FIG. 5 is a flow diagram depicting an example method for determining potential blocking impacts.

FIG. 6 is a flow diagram depicting an example method for determining potential blocking impacts.

### DETAILED DESCRIPTION

The following detailed description refers to the accompanying drawings. Wherever possible, the same reference numbers are used in the drawings and the following description to refer to the same or similar parts. It is to be expressly understood, however, that the drawings are for the purpose of illustration and description only. While several examples are described in this document, modifications, adaptations, and other implementations are possible. Accordingly, the following detailed description does not limit the disclosed examples. Instead, the proper scope of the disclosed examples may be defined by the appended claims.

A blacklist may comprise a plurality of reputable entities (e.g., Internet Protocol (IP) addresses, domain names, e-mail addresses, Uniform Resource Locators (URLs), files, software versions, security certificates, etc.). For example, the blacklist may be used to block, filter out, and/or deny access to certain resources by an event that matches at least one of the plurality of reputable entities.

The plurality of reputable entities in the blacklist may be originated from at least one of a plurality of sources. For example, the reputable entities may be manually created and/or added to the blacklist by a user (e.g., system administrator). In another example, the blacklist may include reputable entities from various reputation services (e.g., threat intelligence feeds providers). These services and/or sources may supply the reputation information on reputable entities that provide information about threats the services have identified. The reputation information, for example, include lists of domain names, IP addresses, and URLs that a reputation service has classified as malicious or at least suspicious according to different methods and criteria.

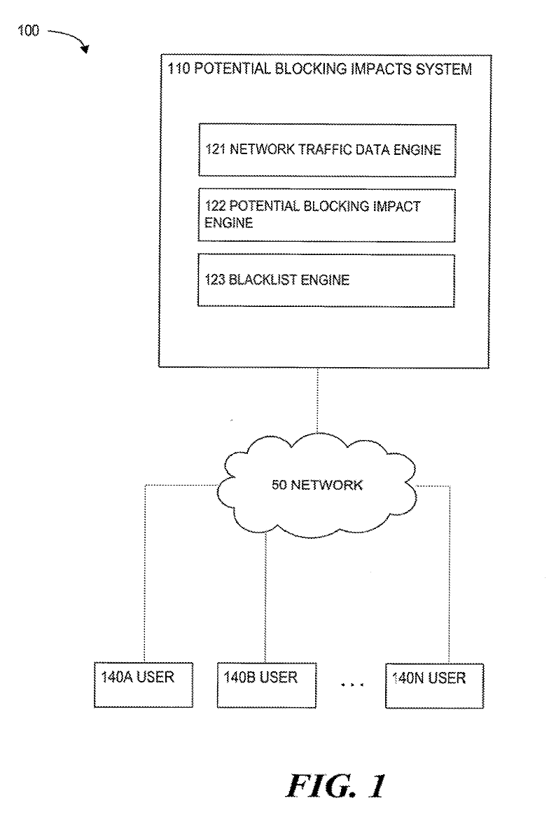

In some instances, a customer (e.g., a recipient of the blacklist) may inadvertently block the reputable entity from their network (e.g., network 50 of FIG. 1) without fully realizing a potential blocking impact of blocking the reputable entity. For example, blocking a popular search engine site (e.g., regardless of whether the site is a current security threat or not) may create a great deal of inconvenience to the users of the network. However, it is technically challenging to determine a potential blocking impact related to a reputable entity and/or have the determined potential blocking impact to be effectively communicated to the customer.

Examples disclosed herein provide technical solutions to these technical challenges by providing a technique to determine a potential blocking impact of blocking a reputable entity. Some of the examples enable obtaining network traffic data of a network that is accessible by a plurality of users. The network traffic data may comprise occurrences of a reputable entity. Some of the examples further enable determining, based on the network traffic data, a potential blocking impact of blocking the reputable entity from the network. Some of the examples further enable providing the potential blocking impact to be used in an application of a network policy to the reputable entity.

The terminology used herein is for the purpose of describing particular embodiments only and is not intended to be limiting. As used herein, the singular forms “a,” “an,” and “the” are intended to include the plural forms as well, unless the context clearly indicates otherwise. The term “plurality,” as used herein, is defined as two or more than two. The term “another,” as used herein, is defined as at least a second or more. The term “coupled,” as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

FIG. 1 is an example environment 100 in which various examples may be implemented as a potential blocking impacts system 110. Environment 100 may include various components including potential blocking impacts system 110, a network 50 that is accessible by a plurality of users 140 (illustrated as 140A, 140B, . . . , 140N). Although not illustrated in FIG. 1, potential blocking impacts system 110 may include a server computing device in communication with client computing devices. The client computing devices may communicate requests to and/or receive responses from the server computing device. The server computing device may receive and/or respond to requests from the client computing devices. The client computing devices may be any type of computing device providing a user interface through which a user can interact with a software application. For example, the client computing devices may include a laptop computing device, a desktop computing device, an all-in-one computing device, a thin client, a workstation, a tablet computing device, a mobile phone, an electronic book reader, a network-enabled appliance such as a “Smart” television, and/or other electronic device suitable for displaying a user interface and processing user interactions with the displayed interface. While the server computing device can be a single computing device, the server computing device may include any number of integrated or distributed computing devices.

In some implementations, potential blocking impacts system 110 may obtain network traffic data of network 50 that may be accessible by the plurality of users 140. The plurality of users 140 may refer to network users that uses network 50 to access various resources. For example, a user (e.g., user 140A) may access a particular website (e.g., a resource) via network 50. A user (e.g., user 140A) may refer to an individual person, an organization, and/or other entity. The user may be identified by a user login, an Internet Protocol (IP) address of a client computing device that the user may use to access network 50, and/or other types of user identifier.

Network 50 may comprise any infrastructure or combination of infrastructures that enable electronic communication between various computing devices. The content of this electronic communication may be referred as “network traffic data,” as used herein. For example, the network traffic data may comprise the record (e.g., a log file) of the data that is exchanged via network 50, which may include but not be limited to domain name requests made by a user (e.g., user 140A), Uniform Resource Locators (URLs) that the user visited, and files that the user has downloaded and/or uploaded. Each data item (e.g., a particular URL) in the network traffic data may be associated with the user (and/or the user identifier thereof) that initiated or otherwise used the data item on network 50. For example, a particular URL in the network traffic data may be associated with the user (and/or the user identifier thereof) who visited the particular URL via network 50.

Network 50 may include at least one of the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. According to various implementations, potential blocking impacts system 110 and the various components described herein may be implemented in hardware and/or a combination of hardware and programming that configures hardware. Furthermore, in FIG. 1 and other Figures described herein, different numbers of components or entities than depicted may be used.

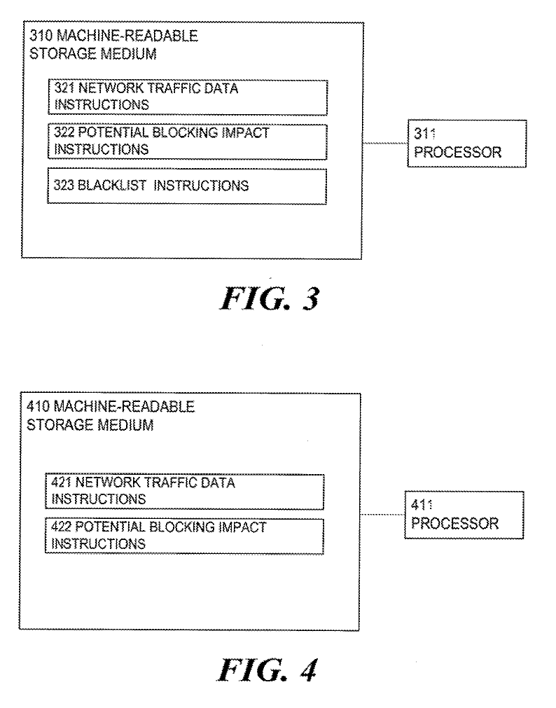

Potential blocking impacts system 110 may comprise a network traffic data engine 121, a potential blocking impact engine 122, a blacklist engine 123, and/or other engines. The term “engine”, as used herein, refers to a combination of hardware and programming that performs a designated function. As is illustrated respect to FIGS. 3-4, the hardware of each engine, for example, may include one or both of a processor and a machine-readable storage medium, while the programming is instructions or code stored-on the machine-readable storage medium and executable by the processor to perform the designated function.

Network traffic data engine 121 may obtain network traffic data of a network that is accessible by a plurality of users. The network such as network 50 may comprise any infrastructure or combination of infrastructures that enable electronic communication between various computing devices. The content of this electronic communication may be referred as “network traffic data,” as used herein. For example, the network traffic data may comprise the record (e.g., a log file) of the data that is exchanged via network 50, which may include but not be limited to domain name requests made by a user (e.g., user 140A), Uniform Resource Locators (URLs) that the user visited, and files that the user has downloaded and/or uploaded. Each data item (e.g., a particular URL) in the network traffic data may be associated with the user (and/or the user identifier thereof) that initiated or otherwise used the data item. For example, a particular URL in the network traffic data may be associated with the user (and/or the user identifier thereof) who visited the particular URL via network 50.

In some implementations, the network traffic data may be collected and/or obtained on a reputable entity (e.g., reputable entity in a blacklist). A blacklist may comprise a plurality of reputable entities (e.g., IP addresses, domain names, e-mail addresses, URLs, files, software versions, security certificates, etc.). For example, the blacklist may be used to block, filter out, and/or deny access to certain resources by an event that matches at least one of the plurality of reputable entities. The plurality of reputable entities in the blacklist may be originated from at least one of a plurality of sources. For example, the reputable entities may be manually created and/or added to the blacklist by a user (e.g., system administrator). In another example, the blacklist may include reputable entities from various reputation services (e.g., threat intelligence feeds providers). These services and/or sources may supply the reputation information on reputable entities that provide information about threats the services have identified. The reputation information, for example, include lists of domain names, IP addresses, and URLs that a reputation service has classified as malicious or at least suspicious according to different methods and criteria.

For example, network traffic data engine 121 may obtain network traffic data related to a particular reputable entity (e.g., a particular URL) identified in a blacklist. Any data exchanged via network 50 regarding the particular reputable entity may be collected and/or obtained. If a user (e.g., user 140A) uses (e.g., accesses, downloads, uploads, visits, etc.) this particular reputable entity via network 50, this occurrence of the particular reputable entity may be logged and/or obtained by network traffic data engine 121. If the same user subsequently accesses the particular reputable entity via network 50, the network traffic data may include this subsequent occurrence of the particular reputable entity. If another user (e.g., user 140B) accesses the same particular reputable entity via network 50, the network traffic data may also include this occurrence of the particular reputable entity. In this case, the network traffic data may comprise 3 occurrences of the particular reputable entity. 2 of 3 occurrences are associated with user 140A while the remaining one is associated with user 140B.

The network traffic data may be collected over a particular time period. For example, the network traffic data may include data exchanges made via network 50 from a start time to an end time. In some implementations, the time period may be adjusted based on the usage characteristics of network 50. For example, if the usage characteristics of network 50 show a great variance (e.g., exceeding a certain threshold) in the usage (e.g., the number of users who used a reputable entity on network 50 is small, the number of occurrences of the reputable entity in the network traffic data is small), it may make sense to require a longer time period over which the network traffic data should be collected to obtain a larger sample size of the network traffic data.

Note that the network traffic data may be organized in various ways. For example, the network traffic data may be organized by entity type, by user, etc. A reputable entity (and/or an occurrence thereof in the network traffic data) may belong to an entity type. For example, first and second domain names may belong to the domain names entity type. A reputable entity (and/or an occurrence thereof in the network traffic data) may be associated with the user (and/or the user identifier thereof) that initiated or otherwise used the reputable entity on network 50. For example, a particular URL in the network traffic data may be associated with the user (and/or the user identifier thereof) who visited the particular URL via network 50.

Potential blocking impact engine 122 may determine a potential blocking impact of blocking a reputable entity from network 50. In one example, the potential blocking impact may be determined based on user input (e.g., a customer such as a recipient of the blacklist may manually input and/or define a potential blocking impact of blocking a particular reputable entity of the blacklist). In another example, publicly available lists of popular reputable entities (e.g., popular websites, files, etc.) can be used to determine the potential blocking impact (e.g., the impact of blocking a popular website may be higher than the impact of blocking a website that is not popular or not frequently visited).

In another example, the potential blocking impact may be determined based on the network traffic data (e.g., obtained by network traffic data engine 121). In doing so, the network traffic data may be analyzed to determine at least one parameter to be used to determine the potential blocking impact. The at least one parameter may include not be limited to: a number of users that have used the reputable entity on network 50 and a number of occurrences of the reputable entity (e.g., occurrences logged in the network traffic data). For example, if there are a large number of users accessing the same URL on network 50, the potential blocking impact of blocking that URL may be great. Further, if there are a large number of occurrences of the URL detected in the network traffic data, the potential blocking impact of blocking this URL can be even greater.

Note that the potential blocking impact has a direct correlationship with the number of users that have used the reputable entity on network 50 and/or the number of occurrences of the reputable entity. In other words, the potential blocking impact is higher when the number of users is higher. The impact is lower when the number of users is lower. The impact is higher when the number of occurrences is higher. The impact is lower when the number of occurrences is lower.

Potential blocking impact engine 122 may provide the potential blocking impact to be used in an application of a network policy to the reputable entity. Network policies may include not be limited to block, allow, quarantine, delay, notify, or any combination thereof. In some implementations, potential blocking impacts system 110 may directly use the potential blocking impact (e.g., provided by potential blocking impact engine 122) to determine (and/or select) a particular network policy and/or to directly apply the determined network policy to the reputable entity. In some implementations, the potential blocking impact may be provided to an external network device for the external network device to make the determination of the network policy and/or to apply the determined network policy to the reputable entity. In some implementations, a blacklist may be generated based on the potential blocking impact (e.g., provided by potential blocking impact engine 122), as further discussed herein with respect to blacklist engine 123.

Blacklist engine 123 may generate a blacklist in part based on the potential blocking impact (e.g., determined by potential blocking impact engine 122). In some implementations, the potential blocking impact of a particular reputable entity may be presented as part of the generated blacklist. For example, a representation (e.g., a numerical score) of the impact may be shown adjacent to where the particular reputable entity is shown in the blacklist such that the customer (e.g., the recipient of the blacklist) can be readily informed of the potential blocking impact of blocking the particular reputable entity. With this additional information about the potential blocking impact present in the blacklist, the customer may make an informed decision on whether to keep the reputable entity in the blacklist or remove the entity from the blacklist. In some implementations, the potential blocking impact may be used as a parameter to determine and/or select reputable entities to be included in the blacklist. For example, a reputation service may consider various parameters in this determination, including a severity parameter. The severity parameter may indicate a severity of a security threat posed by a particular reputable entity. If the particular reputable entity poses a security threat related to “Adware”, the severity with respect to that security threat may be low. If the particular reputable entity poses a security threat related to “Spam,” the severity may be higher than the one related to “Adware.” If the particular reputable entity poses a security threat related to an advances persistent threat, the severity may be higher than the one related to “Spam.”

Blacklist engine 123 may determine an entity score for a particular reputable entity based on a parameter or any combination of various parameters. For example, the entity score may be determined using the severity of a security threat posed by the particular reputable entity, the potential blocking impact of blocking the reputable entity from network 50, and/or other parameters. Using the entity scores associated with a plurality of reputable entities, blacklist engine 123 may sort, rank, select, or otherwise determine the reputable entities that should be included in the blacklist.

Note that the blacklist generated by blacklist engine 123 may be a new blacklist or an updated blacklist that is updated from an initial blacklist. For example, network traffic data 121 may obtain the network traffic data with respect to the reputable entities in the initial blacklist. The network traffic data may then be used to determine a potential blocking impact of each of the reputable entities of the initial blacklist, as discussed herein with respect to potential blocking impact engine 122. Blacklist engine 123 may update the initial blacklist by having the potential blocking impact shown in the initial blacklist, by re-sorting, re-ranking, or otherwise re-determining the reputable entities of the initial blacklist (and/or other reputable entities that may not have existed in the initial blacklist) based on the respective potential blocking impacts, and/or by other ways. In another example, blacklist engine 123 may generate a new blacklist by determining the reputable entities to be included in the new blacklist based on the respective potential blocking impacts and/or other parameters.

In performing their respective functions, engines 121-123 may access data storage 129 and/or other suitable database(s). Data storage 129 may represent any memory accessible to potential blocking impacts system 110 that can be used to store and retrieve data. Data storage 129 and/or other database may comprise random access memory (RAM), read-only memory (ROM), electrically-erasable programmable read-only memory (EEPROM), cache memory, floppy disks, hard disks, optical disks, tapes, solid state drives, flash drives, portable compact disks, and/or other storage media for storing computer-executable instructions and/or data. Potential blocking impacts system 110 may access data storage 129 locally or remotely via network 50 or other networks.

Data storage 129 may include a database to organize and store data. The database may reside in a single or multiple physical device(s) and in a single or multiple physical location(s). The database may store a plurality of types of data and/or files and associated data or file description, administrative information, or any other data.

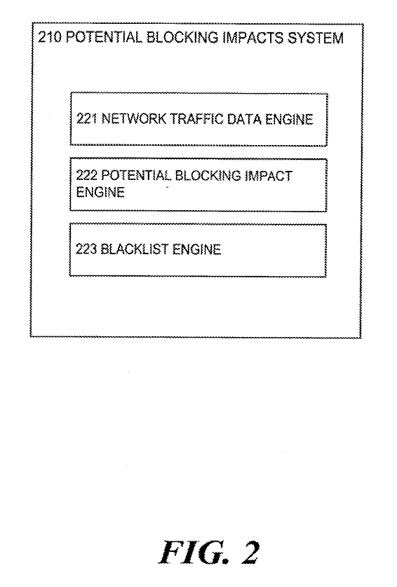

FIG. 2 is a block diagram depicting an example potential blocking impacts system 210. Potential blocking impacts system 210 may comprise a network traffic data engine 221, a potential blocking impact engine 222, a blacklist engine 223, and/or other engines. Engines 221-223 represent engines 121-123, respectively.

FIG. 3 is a block diagram depicting an example machine-readable storage medium 310 comprising instructions executable by a processor for determining potential blocking impacts.

In the foregoing discussion, engines 121-123 were described as combinations of hardware and programming. Engines 121-123 may be implemented in a number of fashions. Referring to FIG. 3, the programming may be processor executable instructions 321-323 stored on a machine-readable storage medium 310 and the hardware may include a processor 311 for executing those instructions. Thus, machine-readable storage medium 310 can be said to store program instructions or code that when executed by processor 311 implements potential blocking impacts system 110 of FIG. 1.

In FIG. 3, the executable program instructions in machine-readable storage medium 310 are depicted as network traffic data instructions 321, potential blocking impact instructions 322, and blacklist instructions 323. Instructions 321-323 represent program instructions that, when executed, cause processor 311 to implement engines 121-123, respectively.

FIG. 4 is a block diagram depicting an example machine-readable storage medium 410 comprising instructions executable by a processor for determining potential blocking impacts.

Referring to FIG. 4, the programming may be processor executable instructions 421-422 stored on a machine-readable storage medium 410 and the hardware may include a processor 411 for executing those instructions. Thus, machine-readable storage medium 410 can be said to store program instructions or code that when executed by processor 411 implements potential blocking impacts system 110 of FIG. 1.

In FIG. 4, the executable program instructions in machine-readable storage medium 410 are depicted as network traffic data instructions 421 and potential blocking impact instructions 422. Instructions 421-422 represent program instructions that, when executed, cause processor 411 to implement engines 121-122, respectively.

Machine-readable storage medium 310 (or machine-readable storage medium 410) may be any electronic, magnetic, optical, or other physical storage device that contains or stores executable instructions. In some implementations, machine-readable storage medium 310 (or machine-readable storage medium 410) may be a non-transitory storage medium, where the term “non-transitory” does not encompass transitory propagating signals. Machine-readable storage medium 310 (or machine-readable storage medium 410) may be implemented in a single device or distributed across devices. Likewise, processor 311 (or processor 411) may represent any number of processors capable of executing instructions stored by machine-readable storage medium 310 (or machine-readable storage medium 410). Processor 311 (or processor 411) may be integrated in a single device or distributed across devices. Further, machine-readable storage medium 310 (or machine-readable storage medium 410) may be fully or partially integrated in the same device as processor 311 (or processor 411), or it may be separate but accessible to that device and processor 311 (or processor 411).

In one example, the program instructions may be part of an installation package that when installed can be executed by processor 311 (or processor 411) to implement potential blocking impacts system 110. In this case, machine-readable storage medium 310 (or machine-readable storage medium 410) may be a portable medium such as a floppy disk, CD, DVD, or flash drive or a memory maintained by a server from which the installation package can be downloaded and installed. In another example, the program instructions may be part of an application or applications already installed. Here, machine-readable storage medium 310 (or machine-readable storage medium 410) may include a hard disk, optical disk, tapes, solid state drives, RAM, ROM, EEPROM, or the like.

Processor 311 may be at least one central processing unit (CPU), microprocessor, and/or other hardware device suitable for retrieval and execution of instructions stored in machine-readable storage medium 310. Processor 311 may fetch, decode, and execute program instructions 321-323, and/or other instructions. As an alternative or in addition to retrieving and executing instructions, processor 311 may include at least one electronic circuit comprising a number of electronic components for performing the functionality of at least one of instructions 321-323, and/or other instructions.

Processor 411 may be at least one central processing unit (CPU), microprocessor, and/or other hardware device suitable for retrieval and execution of instructions stored in machine-readable storage medium 410. Processor 411 may fetch, decode, and execute program instructions 421-422, and/or other instructions. As an alternative or in addition to retrieving and executing instructions, processor 411 may include at least one electronic circuit comprising a number of electronic components for performing the functionality of at least one of instructions 421-422, and/or other instructions.

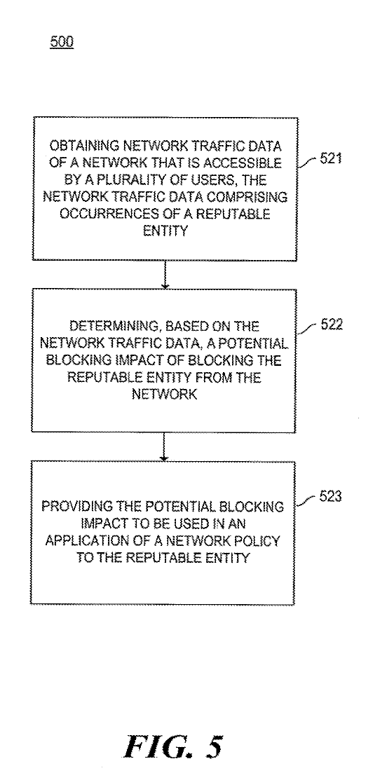

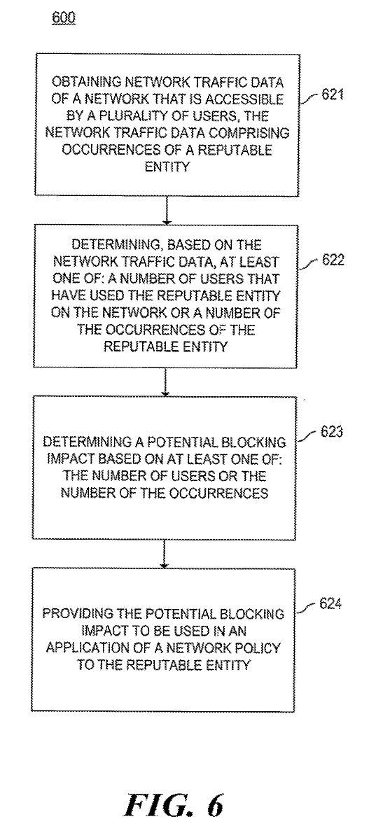

FIG. 5 is a flow diagram depicting an example method 500 for determining potential blocking impacts. The various processing blocks and/or data flows depicted in FIG. 5 (and in the other drawing figures such as FIG. 6) are described in greater detail herein. The described processing blocks may be accomplished using some or all of the system components described in detail above and, in some implementations, various processing blocks may be performed in different sequences and various processing blocks may be omitted. Additional processing blocks may be performed along with some or all of the processing blocks shown in the depicted flow diagrams. Some processing blocks may be performed simultaneously. Accordingly, method 500 as illustrated (and described in greater detail below) is meant to be an example and, as such, should not be viewed as limiting. Method 500 may be implemented in the form of executable instructions stored on a machine-readable storage medium, such as storage medium 310, and/or in the form of electronic circuitry.

In block 521, method 500 may include obtaining network traffic data of a network that is accessible by a plurality of users. The network traffic data may comprise occurrences of a reputable entity. Referring back to FIG. 1, network traffic data engine 121 may be responsible for implementing block 521.

In block 522, method 500 may include determining, based on the network traffic data, a potential blocking impact of blocking the reputable entity from the network. Referring back to FIG. 1, potential blocking impact engine 122 may be responsible for implementing block 522.

In block 523, method 500 may include providing the potential blocking impact to be used in an application of a network policy to the reputable entity. Referring back to FIG. 1, blacklist engine 123 may be responsible for implementing block 523.

FIG. 6 is a flow diagram depicting an example method 600 for determining potential blocking impacts. Method 600 as illustrated (and described in greater detail below) is meant to be an example and, as such, should not be viewed as limiting. Method 600 may be implemented in the form of executable instructions stored on a machine-readable storage medium, such as storage medium 310, and/or in the form of electronic circuitry.

In block 621, method 600 may include obtaining network traffic data of a network that is accessible by a plurality of users. The network traffic data may comprise occurrences of a reputable entity. Referring back to FIG. 1, network traffic data engine 121 may be responsible for implementing block 621.

In block 622, method 600 may include determining, based on the network traffic data, at least one of: a number of users that have used the reputable entity on the network or a number of the occurrences of the reputable entity. Referring back to FIG. 1, potential blocking impact engine 122 may be responsible for implementing block 622.

In block 623, method 600 may include determining a potential blocking impact based on at least one of: the number of users or the number of the occurrences. Referring back to FIG. 1, potential blocking impact engine 122 may be responsible for implementing block 623.

In block 624, method 600 may include providing the potential blocking impact to be used in an application of a network policy to the reputable entity. Referring back to FIG. 1, blacklist engine 123 may be responsible for implementing block 624.

The foregoing disclosure describes a number of example implementations for potential blocking impacts. The disclosed examples may include systems, devices, computer-readable storage media, and methods for potential blocking impacts. For purposes of explanation, certain examples are described with reference to the components illustrated in FIGS. 1-4. The functionality of the illustrated components may overlap, however, and may be present in a fewer or greater number of elements and components.

Further, all or part of the functionality of illustrated elements may co-exist or be distributed among several geographically dispersed locations. Moreover, the disclosed examples may be implemented in various environments and are not limited to the illustrated examples. Further, the sequence of operations described in connection with FIGS. 5-6 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

1. A method for determining potential blocking impacts, the method comprising:
obtaining network traffic data of a network that is accessible by a plurality of users, the network traffic data comprising occurrences of a reputable entity;
determining, based on the network traffic data, a potential blocking impact of blocking the reputable entity from the network; and
providing the potential blocking impact to be used in an application of a network policy to the reputable entity.

2. The method of claim 1, wherein the plurality of users comprises a first user, further comprising:
including a first occurrence of the reputable entity in the network traffic data if the first user uses the reputable entity on the network; and
including a second occurrence of the reputable entity in the network traffic data if the first user subsequently uses the reputable entity on the network.

3. The method of claim 2, wherein the plurality of users comprises a second user, further comprising:
including a third occurrence of the reputable entity in the network traffic data if a second user uses the reputable entity on the network.

4. The method of claim 1, wherein determining the potential blocking impact comprises:
determining, based on the network traffic data, at least one of: a number of users that have used the reputable entity on the network or a number of the occurrences of the reputable entity; and
determining the potential blocking impact based on at least one of: the number of users or the number of the occurrences.

5. The method of claim 4, wherein the potential block impact is higher when the number of users is higher.

6. The method of claim 4, wherein the potential block impact is higher when the number of the occurrences is higher.

7. The method of claim 1, wherein the network traffic data is collected over a time period, further comprising:
adjusting the time period based on at least one of: a number of users that have used the reputable entity on the network or a number of the occurrences of the reputable entity.

8. A non-transitory machine-readable storage medium comprising instructions executable by a processor of a computing device for determining potential blocking impacts, the machine-readable storage medium comprising:
instructions to obtain network traffic data of a network that is accessible by a plurality of users, the network traffic data comprising occurrences of a first reputable entity;
instructions to determine, based on the network traffic data, at least one of: a number of users that have used the first reputable entity on the network or a number of the occurrences of the first reputable entity; and
instructions to determine a first potential blocking impact of blocking the first reputable entity from the network based on at least one of: the number of users that have used the first reputable entity or the number of the occurrences of the first reputable entity.

9. The non-transitory machine-readable storage medium of claim 8, wherein the network traffic data comprises occurrences of a second reputable entity, further comprising:
instructions to determine, based on the network traffic data, at least one of: a number of users that have used the second reputable entity on the network or a number of the occurrences of the second reputable entity; and
instructions to determine a second potential blocking impact of blocking the second reputable entity from the network based on at least one of: the number of users that have used the second reputable entity on the network or the number of the occurrences of the second reputable entity.

10. The non-transitory machine-readable storage medium of claim 9, wherein the network traffic data is related to a particular entity type to which the first and second reputable entities belong.

11. The non-transitory machine-readable storage medium of claim 9, further comprising:
instructions to determine a first entity score for the first reputable entity based on the first potential blocking impact;
instructions to determine a second entity score for the second reputable entity based on the second potential blocking impact; and
instructions to generate a blacklist based on the first and second entity scores.

12. The non-transitory machine-readable storage medium of claim 11, further comprising:
instructions to determine the first entity score based on a first severity of a security threat posed by the first reputable entity; and
instructions to determine the second entity score based on a second severity of a security threat posed by the second reputable entity.

13. A system for determining potential blocking impacts comprising:
the processor that:
obtains network traffic data of a network that is accessible by a plurality of users, the network traffic data comprising occurrences of a reputable entity;
determines, based on the network traffic data, at least one of: a number of users that have used the reputable entity on the network or a number of the occurrences of the reputable entity; and
determines a potential blocking impact of blocking the reputable entity from the network based on at least one of: the number of users that have used the reputable entity or the number of the occurrences of the first reputable entity; and
generates a blacklist including the reputable entity and the potential blocking impact.

14. The system of claim 13, the processor that:
determines a severity of a security threat posed by the reputable entity;
determines an entity score associated with the reputable entity based on the severity and the potential blocking impact; and
generates the blacklist based on the entity score and entity scores associated with other reputable entities.

15. The system of claim 13, wherein the potential blocking impact has a direct correlationship with at least one of: the number of users that have used the reputable entity on the network or the number of the occurrences of the reputable entity.
